(19) United States
(12) Patent Application Publication
(10) Pub. No.: US 2016/0236953 A1
(43) Pub. Date: Aug. 18, 2016

(54) APPARATUS AND METHOD FOR ELECTROCHEMICAL TREATMENT OF WATER

(71) Applicant: OCEANSAVER AS, Drammen (NO)

(72) Inventor: Aage Bjørn ANDERSEN, RAELINGEN (NO)

(73) Assignee: OCEANSAVER AS, DRAMMEN (NO)

(21) Appl. No.: 15/028,104

(22) PCT Filed: Oct. 3, 2014
(86) PCT No.: PCT/EP2014/071245

§ 371 Date: Apr. 8, 2016

(30) Foreign Application Priority Data
Oct. 10, 2013 (GB) 1317960.1

(51) Int. Cl. C02F 1/469

(52) U.S. Cl. CPC C02F 1/4693; C02F 2103/008

(57) ABSTRACT

An electrodialysis unit 8 for treating water, such as a treatment in order to kill microorganisms, comprises: a membrane cell, an anode flow path 52 for directing a portion of an incoming water flow to an anode side of the membrane cell, a cathode flow path 50 for directing a portion of an incoming water flow to a cathode side of the membrane cell, a temperature monitoring device 9a for monitoring the temperature of the water and a heater 9b for increasing the temperature of the water in the anode flow path 52 before it reaches the membrane cell, wherein the heater 9b is arranged to operate to increase the temperature of the water in the anode flow path 52 when the original water temperature is below a predetermined level. A membrane 71 is located between the electrodes (cathodes 68 and anode 70).

The present invention relates to the treatment of water by electrodialysis, such as a treatment in order to kill micro-organisms, preferably treatment of sea water such as ballast water treatment.

As used herein, the term “water” does not generally refer to pure water but instead, as is evident from context, it references water requiring treatment, such as sea water or briny water found in naturally formed bodies of water.

Ballast water is water transported by ships in the ballast water tanks or sometimes in other suitable spaces such as in cargo holds or in cargo tanks. It is pumped into the tanks at a water “donor” location to compensate for the changing of point of gravity as cargo and/or fuel is discharged/consumed and hence to maintain stability. Correct ballasting is essential from a structural point of view and also used for performance reasons in order to ensure proper propeller and rudder immersion, proper bridge view as well as maintaining desired vessel movement and handling characteristics. The ballast water is transported to a water “recipient” location, generally at a point where the vessel is to be loaded with cargo, which is potentially outside the bio-geographic region of that of the ballast water origin. It may then be discharged as cargo is taken on board. Ballast water may host a range of species including zooplankton, phytoplankton, bacteria and viruses. These may not have natural predators at the point of discharge and may establish and reproduce at the new location causing significant problems for the environment, industry and human health.

It is desirable to treat water and particularly ballast water in order to kill or disable micro-organisms and to reduce or remove other pollutants.

WO 2008/047084 describes a method and apparatus for ballast water treatment including the use of electrodialysis in a membrane cell. Electrodialysis of this type is a fluid treatment process based on ion-separation by applying an electric potential difference, either constant or in pulses, between two electrodes separated by an ion-exchange membrane. One electrode will perform as an anode (positive charge) attracting negatively charged ions whilst the other will perform as a cathode (negative charge) attracting positive charged ions. The fluid in the compartment between the membrane and the anode will become characterised by negatively charged ions with an excess of electrons and may be referred to as the concentrate while the fluid in the compartment between the membrane and the cathode will be characterised by the presence of positive ions with a shortage of electrons and may be referred to as the diluate.

In some electrodialysis processes, multiple membrane cells are arranged into a configuration called an electrodialysis stack, with alternating anion and cation exchange membranes forming the multiple membrane cells, generally between a single anode and cathode. Known uses of electrodialysis are large scale brackish and seawater desalination and salt production, and small and medium scale drinking water production. Electrodialysis is also used in the process industry for separation of certain contaminants such as heavy metals.

In the disclosure of WO 2008/047084 ballast water is treated by separating a part of the ballast water from the main flow, passing it through the membrane cell, and returning a product of the membrane cell to the main flow. The returned product is mainly concentrate and this has the effect of disabling or killing micro-organisms in the water. The concept of directing only a part of the water through the electrodialysis treatment unit and returning a product of the membrane cell to the water represented an advance in the art, since an effective water treatment is achieved without the need to pass the entire water flow through the electrodialysis treatment unit.

Thus, the electrodialysis device of WO 2008/047084 provides an advantageous form of electrodialysis treatment for use with water treatments such as ballast water treatment. However, further work in relation to the use of an electrodialysis treatment of this type to treat seawater such as ballast water has identified areas where improvements may be made.

Viewed from a first aspect the invention provides an electrodialysis unit for treating water comprising: a membrane cell, an anode flow path for directing a portion of an incoming water flow to an anode side of the membrane cell, a cathode flow path for directing a portion of an incoming water flow to a cathode side of the membrane cell, a temperature monitoring device for monitoring the temperature of the water and a heater for increasing the temperature of the water in the anode flow path before it reaches the membrane cell, wherein the heater is arranged to operate to increase the temperature of the water in the anode flow path when the original water temperature is below a predetermined level.

It has been found that a temperature of the incoming water below a certain level leads to a significant increase in electrical power required to drive the electrodialysis unit. This increase in power can be greater than the power required to heat the water. Hence, the efficiency of the system is improved by heating the water when the original temperature is too low. The method above requires that the water in the anode flow path be heated before it reaches the membrane cell. Advantageously, the water in the cathode flow path is passed to the membrane cell without any pre-heating. Previously, as described for example in GB2487249, the applicant proposed heating of the incoming water without any suggestion of separation of the water flow prior to heating. Whilst the general concept described in GB2487249 provides significant advantages, it has been found that superior advantages are provided by the more specific feature of pre-heating only the water in the anode flow path.

The advantages arise due to the different chemical reactions occurring on the anode and cathode sides of the electrodialytic cell separated by the membrane. On the anode side an oxidant is generated. The oxidant formation is favoured for temperatures above about 17° C., whereas below that temperature the competing reaction for oxygen formation is favoured. There is a transition temperature range, which is about 14° C. to 18° C., and as the temperature passes into and then out of this range there is a significant change in efficiency. Evidently, there are significant advantages in heating the water fed to the anode side when the water temperature is below the transition temperature, typically about 17° C. Above 17° C. the oxidant formation is stable so there is no real merit in continued increase of the temperature. Hence, the water heating on the anode side is preferably used to raise the temperature to above 17° C., or perhaps 18° C., and not significantly further. In fact, at higher temperatures, for example above 35° C., the chemical reaction changes and can start producing undesirable by-products. Preferably, therefore, the anode water is not heated to beyond 35° C., and more preferably it is not heated to beyond 25° C.

On the cathode side, hydrogen and alkaline compounds i.e. Mg(OH)₂, are formed. Mg(OH)₂ appears in the form of a gel-like substance, which can impede water flow through the cell. Thus it is highly undesirable. Moreover, the formation of hydrogen results in significant safety concerns. Ideally the generation of hydrogen and Mg(OH)₂ should be limited. Temperature in general has the effect of accelerating chemical reactions. Avoiding heating of the cathode water therefore may have a positive effect in relation to the chemical reactions. It also reduces the energy consumption compared to the prior art technique of heating all the water

Moreover, in preferred embodiments the distribution of water and the relative flow rates in the anode and cathode flow paths may be skewed. In particular, the flow rate in the anode flow path may be lower than the flow rate in the cathode flow path, for example the volume flow rate on the cathode side may be at least twice the volume flow rate on the anode side, perhaps a ratio of about three to one, or more. This allows for a “flushing effect” on the cathode side to minimise the build-up of deposits of brucite. This imbalance in the amount of water flowing on each side of the membrane further amplifies the benefit of heating only the water going into the anode side of the membrane cell since this is less than half of the total amount of water and may be a quarter or the total, or less. The benefit in energy consumption is not completely aligned with the reduction in the volume of water requiring heating, since of course some additional heat is required to balance the loss of heat by heat exchange with the cooler water on the cathode side. The benefit is nonetheless still significant.

The electrodialysis unit is preferably for the treatment of sea water, more preferably for treatment of ballast water. The electrodialysis unit may be for installation on a vessel such as a ship.

The heater may be an electrically powered heater or a fuel heater. Preferably however the heater is powered by waste heat, which may for example be provided by waste heat from an engine cooling system or by heat recovered from an engine exhaust. This further improves the efficiency. The heater may include a heat exchanger or similar device. Thus, the anode flow path may be connected for heat transfer with the heater and may, for example, include a flow path through a heat exchange circuit.

The temperature monitoring device may monitor the temperature of the entire incoming water flow, i.e. prior to separation into the anode and cathode flow paths, or it may be for monitoring the anode flow path temperature alone. The temperature monitoring device could alternatively or in addition monitor temperature in the membrane cell, and hence monitor the temperature after heating, if heating has been applied and/or at the exit of the anode side of the membrane cell in order to assess the temperature after heat transfer with the cooler water on the cathode side. In this way the temperature monitoring device performs two functions, monitoring for the temperature of unheated water when no heating is applied, and monitoring the temperature of the heated water in the membrane cell, for example in anode flow paths in the membrane cell, in order to determine if a required temperature has been reached and is being maintained. The temperature monitoring device may take any suitable form, and could for example comprise one or more temperature sensor(s) and a control device, such as a microprocessor.

The predetermined temperature level of the incoming water that triggers heating of the anode water is preferably set such that the above mentioned drop in efficiency of the anode reactions is avoided. The temperature at which this occurs may vary for differing water compositions but typically it is in the range 10° C. to 18° C. In a preferred embodiment the heater is operated to increase the temperature of the incoming water when the original temperature is below 10° C., more preferably when the original temperature is below 15° C. and yet more preferably when the temperature is below 16° C. It has been found that for sea water a significant increase in power usage occurs when the temperature drops below about 15° C. or 16° C., this being a consequence of the change in efficiency of the chemical reaction as described above. The water may be heated to above 15° C., preferably above 16° C., more preferably to at least 17° C., more preferably to at least 18° C. and optionally to 20° C. or above. It has been found that for sea water there are no significant reductions in power usage for temperatures in excess of about 20° C. The temperature that the anode water is heated to is preferably sufficient to maintain a temperature of above 15° C., preferably above 16° C., more preferably above 17° C., and more preferably above 18° C. on the anode side along the whole extent of the membrane cell.

It will be understood that heat may be lost as the water passes through the cell and therefore there is a compromise to be made where initial overheating (i.e. heating above the optimal temperature) may be required to ensure that the required minimum temperature is maintained throughout the cell.

Viewed from a second aspect the invention provides a method of treating water by electrodialysis using a membrane cell, wherein the membrane cell is connected to an anode flow path for directing a portion of an incoming water flow to an anode side of the membrane cell and a cathode flow path for directing a portion of an incoming water flow to a cathode side of the membrane cell, the method comprising: monitoring the temperature of incoming water and increasing the temperature of the water in the anode flow path before it reaches the membrane cell if the original water temperature is below a predetermined level.

As with the apparatus above, this method involves heating of the water for the anode side, and advantageously the water for the cathode side of the membrane cell is not heated.

Preferably the method is a method of treating sea water, more preferably a method of treating ballast water. The method may be for treatment of ballast water on board a vessel such as a ship.

The step of heating the water in the anode flow path may use a heater. The heater may be an electrically powered heater or a fuel heater. Preferably however the method comprises heating the water by using recovered heat, which may for example be waste heat from an engine cooling system or heat recovered from an engine exhaust. The heating of the water in the anode flow path may include passing the water through a heat exchange circuit, for example, for heat exchange with water heated by engine cooling or exhaust heat.

A preferred embodiment comprises increasing the temperature of the incoming water when the original temperature is below 10° C., more preferably when the original temperature is below 15° C. and yet more preferably when the temperature is below 16° C. The water may be heated to above 15° C. , preferably above 16° C., more preferably above 17° C., yet more preferably to at least 18° C. and optionally to 20° C. or above.

The temperature that the anode water is heated to is preferably sufficient to maintain a temperature of above 15° C., preferably above 16° C., more preferably above 17° C. and yet more preferably above 18° C. on the anode side along the whole extent of the membrane cell.

Excessive heating can create problems and does not provide additional power saving, as explained above. Hence, preferably the anode water is not heated to beyond 35° C., and more preferably it is not heated to beyond 25° C.

Viewed from a third aspect the invention provides a method of manufacturing an electrodialysis unit comprising providing a membrane cell, providing an anode flow path for directing a portion of an incoming water flow to an anode side of the membrane cell, providing a cathode flow path for directing a portion of an incoming water flow to a cathode side of the membrane cell, providing a temperature monitoring device for monitoring the temperature of the water, and providing a heater for increasing the temperature of the water in the anode flow path before it reaches the membrane cell, the heater being arranged to operate to increase the temperature of the water in the anode flow path when the original water temperature is below a predetermined level.

The electrodialysis units of the aspects and preferred embodiments described above may include one or more of the following features and/or may be incorporated in a water treatment apparatus including any of the following features.

The membrane may be any suitable membrane for use in the electrodialysis of water, such as a water impermeable ion-exchange membrane. An ion selective membrane may optionally be used, for example if the membrane cell is to be powered by AC electricity.

Preferably the electrodialysis treatment is for producing a product of the electrodialysis unit that is then mixed with water requiring treatment to kill or disable micro-organisms. Thus, the electrodialysis unit may be part of a larger water treatment system which may include a tank or reservoir for storing the mixture of the product of the electrodialysis unit and other water requiring treatment.

The electrodialysis treatment is preferably applied to only a part of the water to be treated, with this part being separated from a main body of the water (leaving a remainder of the water behind) and a product of the electrodialysis unit being returned to the remainder of the water to treat the mixture of the remainder of the water and the water formed into the product of the electrodialysis cell. In a preferred water treatment apparatus the part of the water treated by the electrodialysis unit is separated from the main water flow just prior to treatment and then passed through the electrodialysis unit as the remainder of the water passes by without being treated by the electrodialysis unit. Thus, a water treatment apparatus may include a main flow path and an inlet flow path that is arranged to separate a portion of the flow from the main flow path and direct it through the electrodialysis unit. Alternatively, the part of the water treated by the electrodialysis unit can be provided from a separate source, for example an external source of brine or saltwater. In both cases, the water treatment apparatus may include a connection from an outlet flow path of the electrodialysis unit to a main flow path or to the tank or reservoir, wherein the outlet flow path adds a product of the electrodialysis unit to the water to be treated, which may for example be the remainder of the water as discussed above.

The water that is not treated by the electrodialysis unit can be exposed to other treatments, effectively in parallel with the electrodialysis treatment to the said part of the water, for example a cavitation treatment or a nitrogen injection treatment as discussed in the preferred embodiment.

Preferably less than 10% by volume of the total water flow into the treatment apparatus passes through the electrodialysis unit, more preferably less than 5% and yet more preferably less than 2%. An amount of about 1.6% by volume is preferred, although depending on conditions, amounts as low as 1% or 0.5% could be used. It is possible to manipulate the necessary flow volume by altering the current used in the electrodialysis unit and the salinity of the water. Thus, depending on these factors and the particular application of the treatment, the flow volume used can be larger or smaller.

In preferred embodiments, the electrodialysis unit is incorporated in a ballast water treatment apparatus. For example, the main flow path may be a flow of incoming ballast water, a part of this ballast water may be separated for treatment by the electrodialysis unit, and a product of the electrodialysis unit may be returned to the remainder of the ballast water to treat the water. The water may be stored in a ballast tank for a period of time whilst the treatment occurs. The electrodialysis unit may be fluidly connected to a ballast water source and may be supplied with water from a ballast pump. The electrodialysis unit may also be fluidly connected to a ballast tank and may provide a product of the electrodialysis unit to the ballast tank.

As discussed above, water treatment of this type is particularly desirable for ballast water. Many existing water treatments are not suitable for ballast water treatment due to the high volume of water that needs to be treated in a short space of time. As only a part of the water needs to be passed through the electrodialysis unit, with the remainder of the water not passing through the electrodialysis unit, the treatment can be applied to a much higher volume of water in a given time than alternatives which require the entirety of the water to be directly affected by an electrical treatment.

The electrodialysis unit may be for producing a diluate stream and a concentrate stream at the cathode and anode respectively, with the product of the electrodialysis unit that is returned to the water to be treated being composed of some or all of one or both of these streams. The product of the electrodialysis unit may simply be some or the entire concentrate stream produced by the electrodialysis unit. However, preferably the product of the electrodialysis unit is some or all of the concentrate stream, ideally a major portion thereof, mixed with at least a portion of the diluate stream, ideally in a smaller amount than the amount of concentrate. The concentrate stream contains an increased content of different oxidants and the oxidants are particularly effective at killing or disabling micro-organisms in the water when the product of the electrodialysis unit is returned to the main water flow.

After the electrodialysis treatment, the concentrate may have a lower pH than the water prior to treatment, and the diluate may have a higher pH. Mixing the concentrate with some or all of the diluate allows the pH of the product of the electrodialysis unit to be adjusted.

In a preferred embodiment the concentrate stream and at least a portion of the diluate stream are mixed immediately after passing through the electrodialysis unit. This may be done by removing a portion of the diluate stream, and then mixing the remainder of the diluate with the concentrate stream. The amount of diluate removed may be between 20% and 80% by volume. In alternative preferred embodiments, the product of the electrodialysis unit that is returned to the main water flow is all of the diluate stream along with all of the concentrate stream. It has been found that in some circumstances the entirety of the diluate is required to provide the desired pH and other characteristics of the final water flow after the product of the electrodialysis unit is mixed in. In this case, the diluate and the concentrate may react together to consume some of the oxidants and reactive products in the water. However, reactions to kill micro-organisms will also occur before all the oxidants and reactive products are consumed by reaction of the diluate and concentrate. Moreover, the electrodialysis process is not completely reversible. In particular, in the context of ballast water and natural water in general, especially salt water, the reactions within the electrodialysis unit are not fully reversed if the diluate and concentrate are mixed together later on. For example, the reaction may produce gasses such as hydrogen and chlorine which exit the water and heat which is unrecoverable.

In order to control the mixing ratio pH is monitored and balancing is controlled to keep pH in the desired range. The pH monitoring may be by means of a pH electrode. Preferably, the pH is maintained below 6, for example within a range from 4 to 6, typically at a pH of about 5. The mixing ratio and the pH of the product of the electrodialysis unit may be controlled by varying the amount of diluate added to the concentrate, for example by varying the amount of diluate removed prior to mixing. Control of the pH may also occur by controlling the current or voltage supplied to the electrodialysis unit, to thereby vary the strength of the resultant electrodialytic effect and hence vary the oxidative strength of the concentrate.

The apparatus may include a diluate removal flow path for removing a part of the diluate stream. To facilitate mixing of the concentrate and non-removed diluate the apparatus may include a mixing area prior to the outlet flow path. In one preferred embodiment, the mixing area is a buffer tank. Alternatively, the concentrate and diluate may be mixed as they flow through the outlet flow path. Mixing may occur at the same time as the concentrate stream and non-removed part of the diluate stream are mixed with the main flow, i.e. the product of the electrodialysis unit may consist of two parts which are only mixed when these two parts are mixed with the rest of the water. Mixing may be promoted by a static mixer or turbulence inducing means in the mixing area or in the outlet flow path.

The removed diluate may be re-injected to the water upstream prior to the electrodialysis unit. If other treatment stages are included in a water treatment apparatus, such as a cavitation treatment or filtration treatment then the remainder of the diluate is preferably re-injected prior to other treatment stages and even prior to the ballast pump. Re-injecting the diluate avoids the need to dispose of it. The diluate will also advantageously act as a cleaning agent, in particular for the filtering processes if it is injected prior to filtering.

The characteristics and amounts of concentrate and diluate reinjected into the main flow may be controlled by monitoring Oxygen Reduction Potential (ORP) and/or the consumption of Total Residual Oxidant (TRO). The ranges for desired values of ORP may be 250-800 mV, more preferably 300-500 mV. The immediate initial values of TRO following reinjection is preferably between 1 and 10 mg CI/L more preferably between 2 and 5 mg CI/L dropping rapidly to 0.01-1 mg CI/L after a period of 1 to 36 hours typically. The consumption of TRO is strongly dependent upon the characteristics of the water to be treated. To optimise the performance of the electrodialytic unit, it is desirable to arrange a calibration flow loop allowing pre-setting of current and mixing ratios prior to initiating actual water treatment. When the ORP and/or TRO measured values are outside the desired ranges, then the operation of the electrodialysis unit is adjusted accordingly.

To direct the water flow, the apparatus may comprise conduits, pipes, baffles and the like. The electrodialysis unit may be integrated into a flow path for the main water flow, and thus the apparatus may include a main flow pipe or conduit for the main flow, with smaller pipes or conduits or the like for channelling a part of the main flow through the unit. Alternatively, the electrodialysis unit may be provided as a standalone unit which can be connected to an existing water conduit to treat the water therein. In this case, the treatment apparatus may include suitable pipes or conduits for connection of the standalone unit to the existing conduit, along with valves, dosage pump(s) and so on as required.

An independent source of brine may be used to augment the input electrolyte for the electrodialysis unit and increase its salinity. This might for example be brine produced as a by-product of freshwater production or in a dedicated brine production plant, such as a reverse osmosis plant. A recirculating reverse osmosis plant may be used to generate a saturated brine solution for use as an addition to the input electrolyte. The addition of brine or the like is required when the system is used to treat fresh water or weakly brackish water, as otherwise the electrical treatment will not be effective due to a lack of ions in the water. Brine may be also added to sea water with a low salt content in order to bring the salt content of the electrolyte to a more preferred level. At lower salt contents a larger electrical current is required to achieve the same treatment effect with the electrodialysis unit. Consequently, by increasing the salt content a reduction in energy usage can be obtained. As an example, in the North Sea a salinity of 25 parts per thousand or higher is typical, whereas in the Baltic Sea surface waters have a much lower salinity, of perhaps 7 parts per thousand. Preferably, brine is added to the input electrolyte to the electrodialysis unit to maintain a salinity of at least 25 parts per thousand.

Preferably, the water is stored for a period of time in a reservoir or tank after treatment. This allows time for the oxidants and reactive substances from the product of the electrodialysis unit to have full effect on any micro-organisms and other unwanted matter in the water. In a particularly preferred embodiment, the invention is used in ship's ballast water treatment, wherein the water is treated as it is taken in to the ballast tanks, and then it is stored in the ballast tanks before discharge. In this circumstance there is generally a reasonable time of storage as the ship moves from port to port before re-loading with cargo and discharging the ballast water. This time can be advantageously put to use in allowing the treatment by the product of the electrodialysis unit to take effect.

The treatment flow path may be formed by a conduit external to the main flow path. This allows an existing water flow path to be easily adapted to include the treatment apparatus by the addition of an appropriate inlet and outlet junction. Alternatively, the treatment flow path may be integrated with the main flow path as a single unit.

Preferred embodiments of the invention will now be described by way of example only and with reference to the accompanying drawings in which:

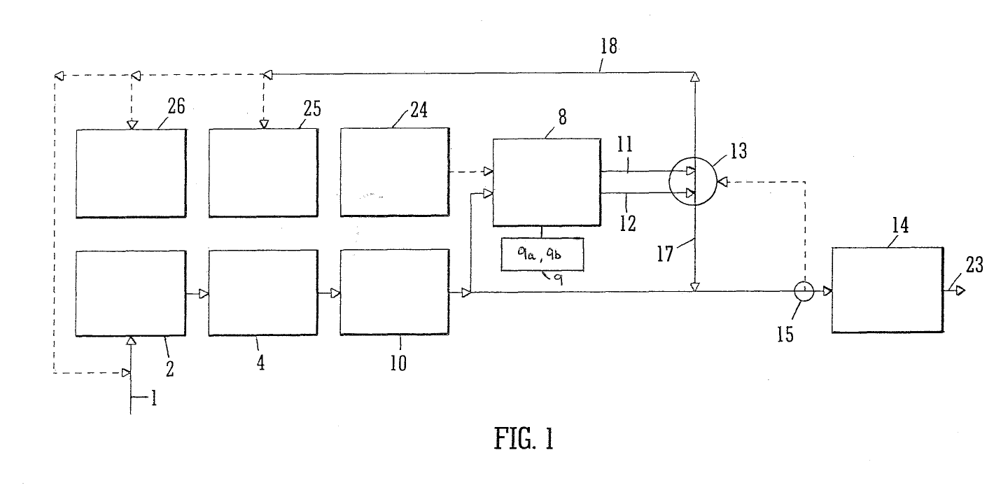

FIG. 1 shows a ballast water treatment system with an electrodialysis unit,

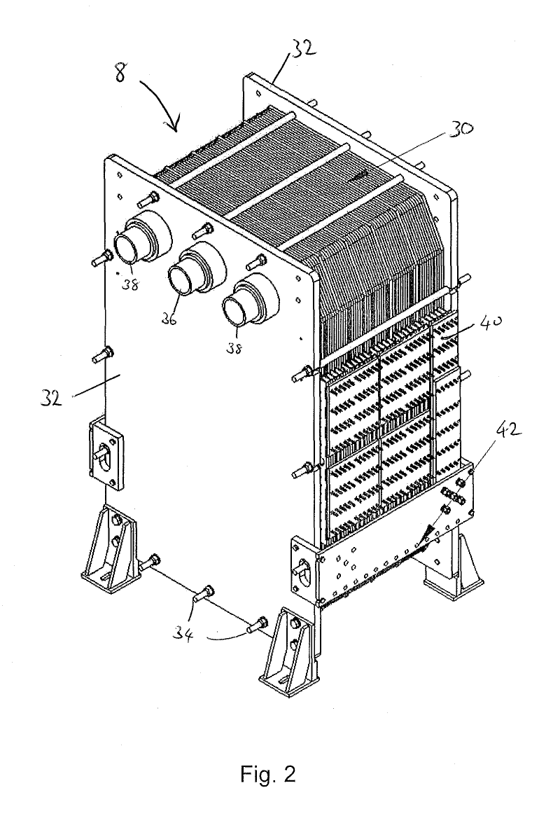

FIG. 2 illustrates an electrodialysis unit including a stack of electrodes,

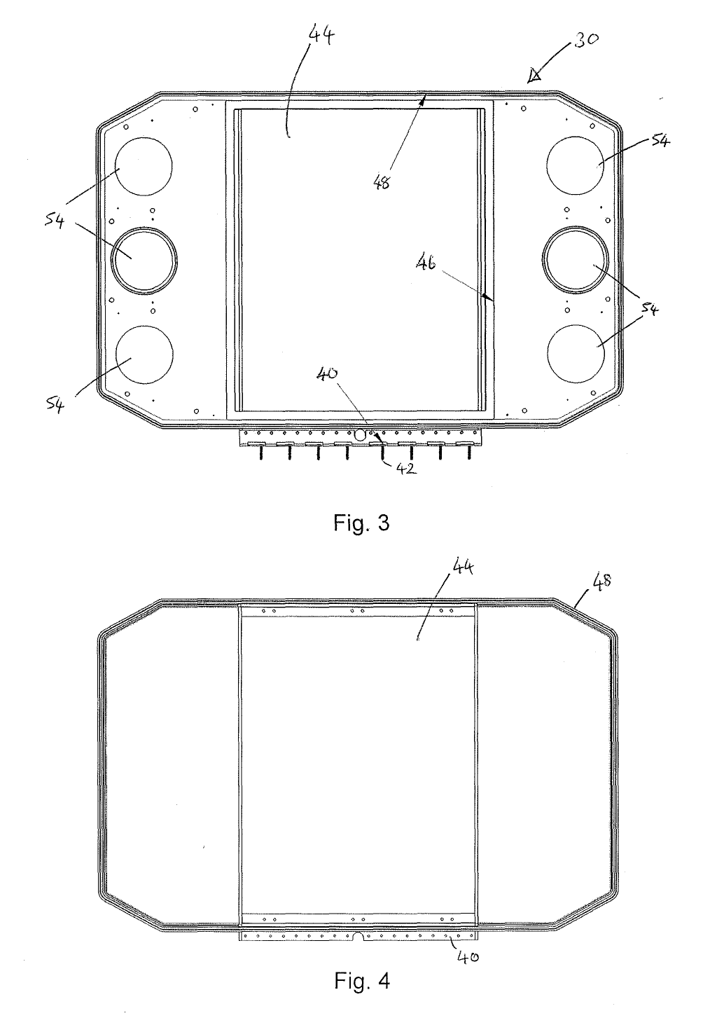

FIG. 3 shows a single electrode chamber as used in the unit of FIG. 2,

FIG. 4 shows an electrode plate and seal,

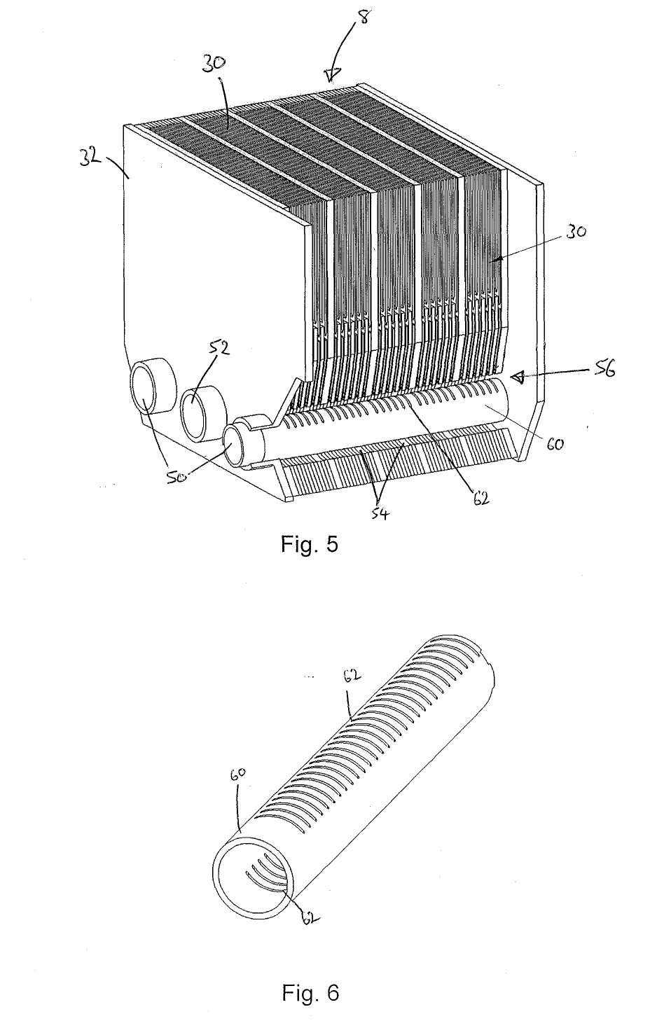

FIG. 5 is a partial cutaway view of an electrodialysis unit in which a flow distributor can be seen,

FIG. 6 is a perspective view of the internal tube of the flow distributor,

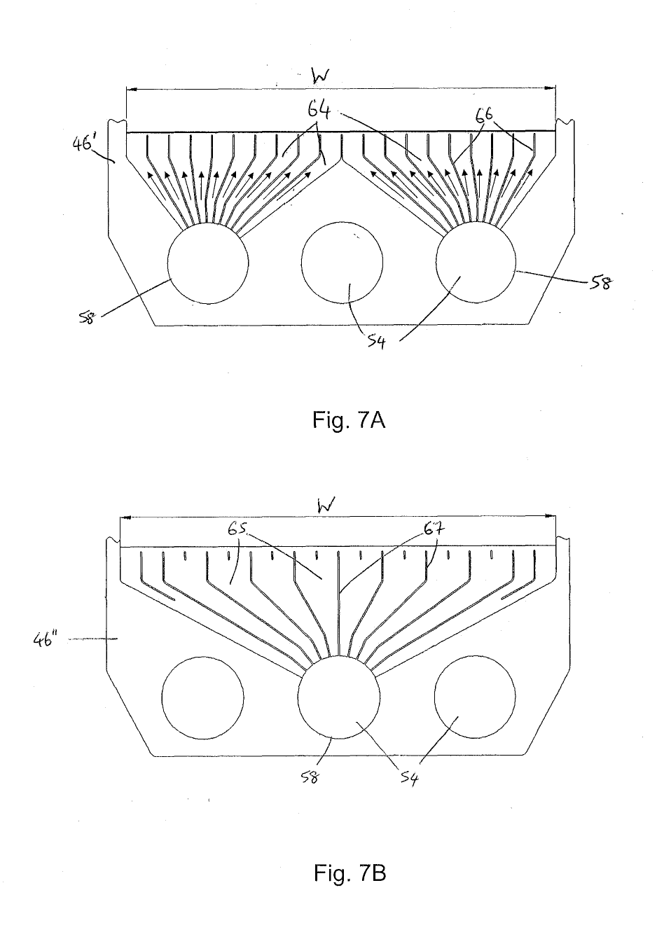

FIG. 7 is a partial view of a separator showing flow conditioning elements,

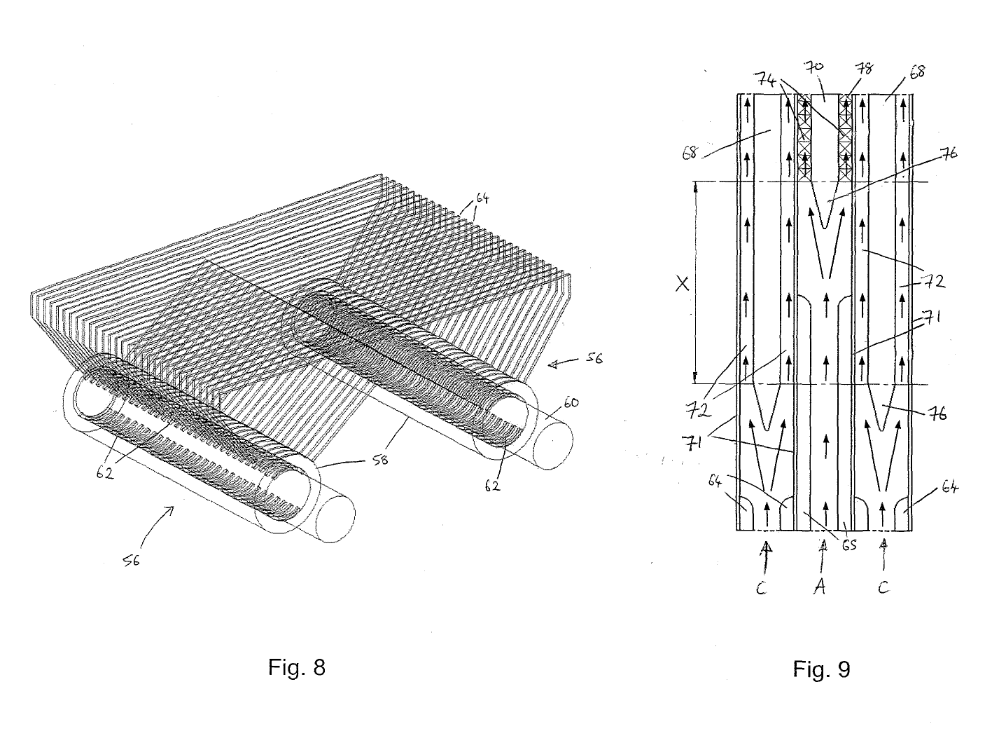

FIG. 8 is a schematic wireframe drawing showing further detail of the flow distributor and flow conditioning elements,

FIG. 9 is a cross-section through a portion of two cathode chambers and one anode chamber showing the leading edges of the electrodes,

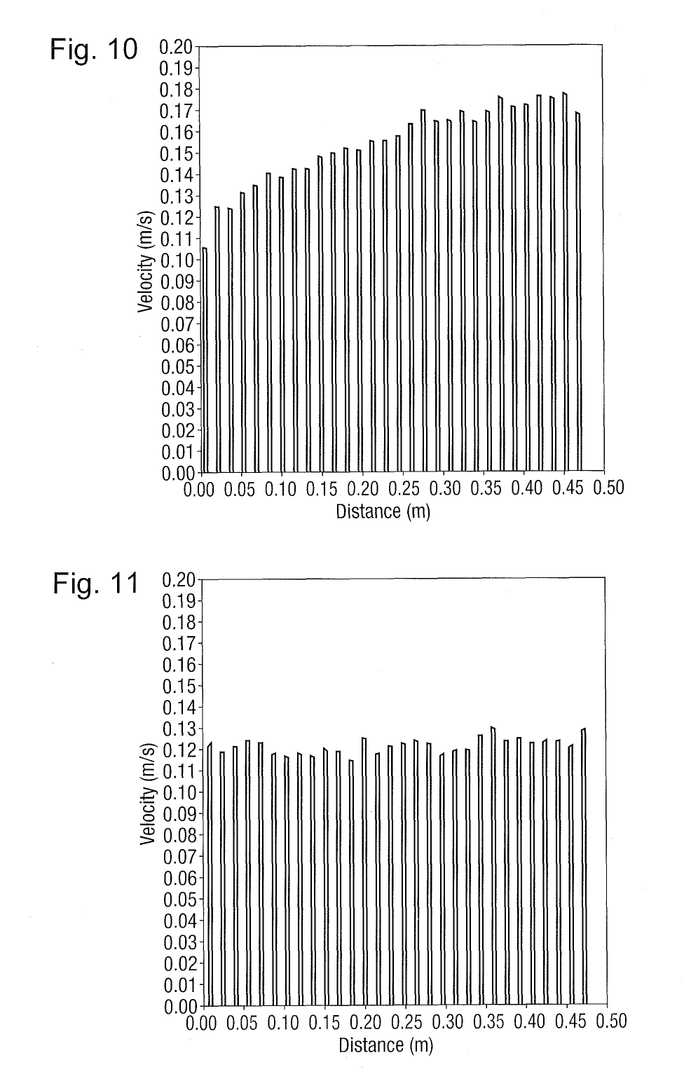

FIG. 10 shows a plot of velocity across each of the cathode chambers along the electrode stack in a computer model when the flow distributor is not used,

FIG. 11 shows a plot of velocity across each of the cathode chambers along the electrode stack in a computer model when the flow distributor is used,

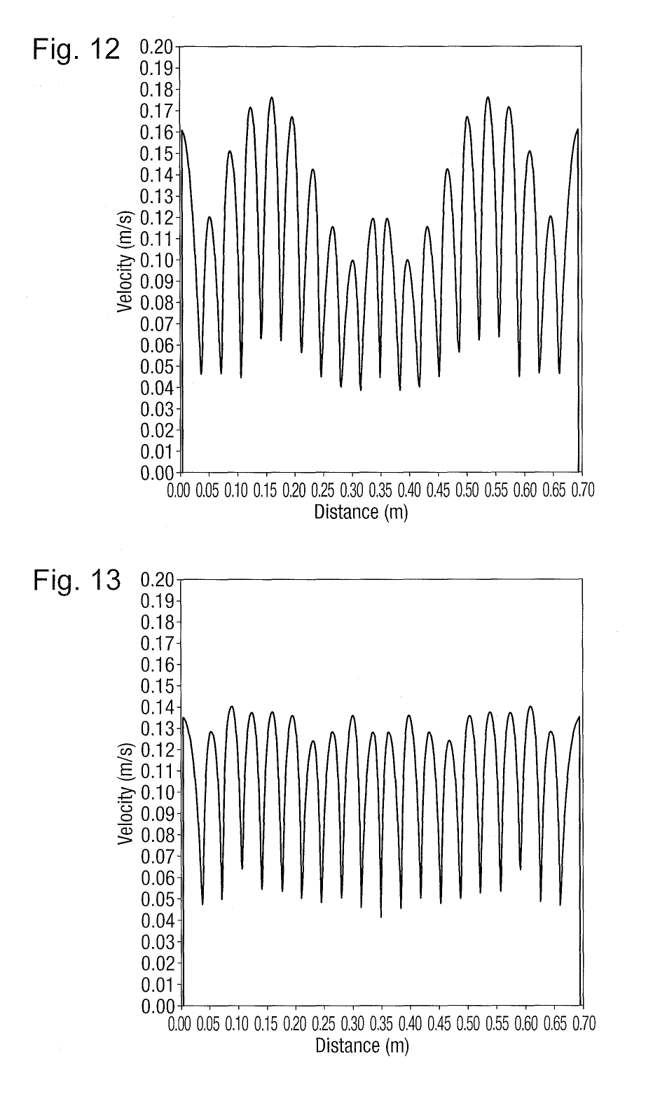

FIG. 12 shows a plot of velocity across the width of a cathode flow path in a computer model when the flow conditioning elements are not used, and

FIG. 13 shows a plot of velocity across the width of a cathode flow path in a computer model when the flow conditioning elements are used.

The arrangement of FIG. 1 utilises an electrodialysis unit within a ballast water treatment system, but it will be appreciated that other uses for the preferred electrodialysis unit exist, and that the electrodialysis unit can be adapted to suit different requirements. In particular, it should be understood that the electrodialysis unit described herein can be used in ballast water treatment, or in other water treatment applications, without the need for combination with other treatment types as shown in the exemplary arrangement of FIG. 1.

FIG. 1 thus illustrates a ballast water treatment system that includes an electrodialysis unit 8. In this example, the water is filtered and then treated by a cavitation unit 10, a gas injection unit 14 and the electrodialysis unit 8. The cavitation unit 10 and gas injection unit 14 are not essential and can be omitted. Some preferred embodiments use a combination of filtering and electrodialysis without other treatments. The treatment causes damage and death to organisms in the water.

As well as affecting organisms in the water, nitrogen optionally added to the water at the injection unit 14 reduces the level of dissolved oxygen in the water and reduces the potential of re-growth of organisms as well as reducing the weathering of coatings and the speed of corrosion. Furthermore, the reduction in oxygen is thought to prolong the effect of oxidants introduced into the water via the product of the electrodialysis unit 8. By controlled atmosphere management when the ballast tanks are empty by using nitrogen, these effects are enhanced further.

During filling of the ballast tanks, ballast water is pumped from the sea through an inlet pipe 1 by the use of the ship's ballast pump system 2. After the pump 2, water flows through a pipe and is filtered through a first filter 4, which filters larger particles from the water. These form a sludge which is discharged at the point of ballast uptake.

Downstream of the first filter 4, a pressure booster may optionally be installed. The pressure booster can be used to maintain the level of water pressure needed for successful treatment in the units further downstream.

In this example, water then continues to flow into the cavitation unit 10, which is an optional treatment device and could be omitted. In the cavitation unit 10, hydrodynamic cavitation is induced by a rapid acceleration of the fluid flow velocity, which allows the fluid static pressure to rapidly drop to the fluid vapour pressure. This then leads to the development of vapour bubbles. After a controlled period of time which allows bubble growth, a rapid controlled deceleration then follows. This causes the fluid static pressure to rise rapidly which causes the vapour bubbles to violently collapse or implode exposing any organisms or the like in the water to the high intensity pressure and temperature pulses, which breaks down the organisms in the water.

After the cavitation unit 10, a part of the water flows through the electrodialysis unit 8. The remainder of the water is not treated by the electrodialysis unit 8, and can simply continue to flow along a pipe or conduit to the later treatment stages. In the embodiment of FIG. 1 the electrodialysis unit is fitted externally to the main flow conduit, and thus could be retro-fitted to an existing treatment system.

The electrodialysis unit 8 of the preferred embodiment is provided with a temperature control system 9. This is used to ensure that the water utilised by the electrodialysis unit 8 does not drop below a set temperature. The temperature control system 9 includes a temperature monitoring device 9a for monitoring the temperature of incoming water and a heater 9b for increasing the temperature of the incoming water for the anode side before it reaches the membrane cell of the electrodialysis unit 8. The heater 9b is arranged to operate to increase the temperature of the incoming water for the anode side when the original water temperature is below a predetermined level. The water for the cathode side of the membrane cell is not heated. In this embodiment the predetermined level is 16° C. If the temperature of the incoming water is below 16° C. then the water is heated up to about 20° C. using the heater. The temperature is selected to ensure that the anode water temperature is sufficiently high, for example above about 16° C. or above about 18° C., along the entire extent of the membrane cell, even after heat is lost to the cooler water on the cathode side. There may be a temperature sensor at the exit for the anolyte to directly monitor the temperature, but this is not essential since the heat transfer rate can be determined for a given membrane cell and cathode/anode flow rates by routine testing. The heater 9b uses waste heat from the ship's engines and may take any suitable form, for example it may be a tube in tube heat exchanger.

The electrodialysis unit 8, which is described in more detail below with reference to FIGS. 2 to 9, produces a diluate stream 11 and a concentrate stream 12. These two streams progress to a pH balancer or mixing unit 13, which produces a product 17 of the electrodialysis unit 8 that is directed back into the main water flow, and depending on the composition of the product 17, the mixing unit 13 may also give out a residue of diluate 18. The mixing unit 13 includes a pump or the like to control the amount of diluate 11 which is added to the concentrate 12 to form the optimum product 17 of the electrodialysis unit 8.

Downstream of the point of injection of the product 17 of the electrodialysis unit 8 there is a sampling and measurement point 15, which measures ORP and/or TRO and communicates the measured values to the mixing unit 13. These measurements monitor the effect of the electrodialysis unit 8 on the water and are used to control the mixing unit 13, for example by controlling a dosing pump.

The diluate residue 18 may be reinjected into the incoming water prior to all treatment steps, and preferably also before the filter 4 and/or the ballast water pump 2. Alternatively, it may be stored in a holding tank 25 or ship's bilge water tank 26.

In the arrangement shown, the gas injection unit 14 treats the water after the product 17 of the electrodialysis unit 8 is returned to the main flow. However, in alternative arrangements the product 17 is returned to the main flow downstream of the gas injection unit 14, with the monitoring unit 15 likewise downstream of the gas injection unit 14, monitoring the water conditions after the product 17 has been mixed in.

In the optional gas injection unit 14, nitrogen gas 16 is injected into the incoming water using a steam/nitrogen injector or a gas/water mixer in order to achieve the desired level of nitrogen super-saturation in the water, which kills organisms and reduces corrosion by reducing the oxygen level. This also prolongs the treatment effect of the oxidants in the water.

Downstream of the treatment units, treated water is distributed by the ship's ballast water piping system 23 to ballast water tanks. Here, excess gas is optionally evacuated until a stable condition is achieved. This is regulated by means of valves integrated with the tanks ventilation system. These valves ensure stable conditions in the tank during the period the ballast water remains in the tank, in particular a high level of nitrogen super-saturation and a low level of dissolved oxygen in the water. Maintaining the level of super-saturation leads to an on-going water treatment both by the super-saturation itself and also by oxidants introduced by the electrodialysis unit 8. The treatment thus results in treated water that continues to kill or disable any surviving organisms whilst the water is stored in the ballast tanks.

Water is then left to rest in the ballast water tanks. In the ballast tanks chemical reactions resulting from the electrodialysis treatment continue to occur, killing and/or disabling micro-organisms in the ballast water. When the ballast water is discharged, water flows through a discharge treatment process that returns the oxygen content of the water to an environmentally acceptable level for discharge. The water is pumped from the ballast tanks and passes through at least the gas injection unit 14. This is used to return oxygen to the water as air replaces nitrogen as the injection gas. Optionally, the water may be re-treated by the cavitation unit 10 as it is discharged.

The operation of the electrodialysis unit 8 will now be explained. An embodiment of the structural arrangement of electrodialysis unit 8 is described below with reference to FIGS. 2 to 9. As discussed above, electrodialysis is an electro-membrane process where ions are transported through ion exchange membranes in a fluid system. In the simplest implementation of an electrodialysis unit a single membrane is placed between two electrodes. An electric charge established by applying a voltage between two electrodes allows ions to be driven through the membrane provided the fluid is conductive. The voltage is applied by power connection points of a conventional type, which are not shown in the drawings. The two electrodes represent respectively the anode and the cathode. The electric charge creates different reactions at the different electrodes. At the anode, the electrolyte will have an acidic characteristic whilst at the cathode, the electrolyte will be characterised by becoming alkaline. Membranes used in electrodialysis are chosen for the ability to allow ion exchange whilst being liquid impermeable. This allows the alkaline solution to be kept separate from the acidic solution.

Various reactions which occur in an electrodialysis membrane cell where the incoming electrolyte is ballast water taken from a ballast water pipeline (i.e. sea water) are shown in Table 1 below. This includes a reaction on the cathode side that produces brucite (Mg(OH)₂). Other reactions will also occur since various compounds may be present in the water in addition to sodium and magnesium salts.

TABLE 1

| Reactions at the anode: | Reactions at the cathode: |
|---|---|
| 2Cl⁻ − 2e → Cl₂ | 2H₂O + 2Na⁺ + 2e → 2NaOH + H₂ |
| 2H₂O − 4e → 4H⁺ + O₂ | 2H₂O + 2e → H₂ + 2OH⁻ |
| Cl₂ + H₂O → HClO + HCl | O₂ + e → O₂⁻ |
| HCl + NaOH → NaCl + H2 | O₂⁻ + H⁺ → HO₂ |
| Cl⁻ + 2OH⁻ − 2e → ClO⁻ + H₂O | O₂ + H₂O + 2e → HO₂⁻ + OH⁻ |
| 3OH⁻ − 2e → HO₂⁻ + H₂O | O₂ + 2H₂ + 2e → H₂O₂ + 2OH⁻ |
| HO₂⁻ − e → HO₂ | H⁺ + e → H^{•} |
| OH⁻ − e → OH^{•} | H^{•} ⁺ H^{•} → H₂ |
| OH^{•} ⁺ OH^{•} → H₂O₂ | OH^{•} ⁺ OH^{•} → H₂O₂ |
| HClO + H₂O₂ → HCl + O₂ + H₂O | H₂O₂ + OH^{•} → HO₂ + H₂O |
| ClO⁻ + H₂O₂ → ¹O₂ + Cl^{•} + H₂O | H₂O₂ [symbol] H⁺ + HO₂⁻ |
| | H₂O₂ + OH⁻ [symbol] HO₂⁻ + H₂O |
| | OH⁻ + HO₂⁻ [symbol] O₂²⁻ + H₂O |
| | O₂²⁻ + H₂O₂ → O₂⁻ + OH⁻ + OH |
| | OH + H₂O₂ → H₂O |
| | OH⁻ + HCO₃₋ + Ca²⁺ = CaCO₃ + H₂O |
| | 2OH⁻ + Mg²⁺ = Mg(OH)₂ |

Table 2 below illustrates typical properties for an acidic solution produced at the anode and an alkaline solution produced at the cathode. The acidic solution forms the concentrate stream and the alkaline solution forms the diluate stream.

TABLE 2

| | pH | TRO (mg Cl/L) | ORP (mV) |
|---|---|---|---|
| Acidic solution (at the anode) | 2-4 | 400-1200 | 1100-1200 |
| Alkaline solution (at the cathode) | 11-14 | — | 800-900 |

The two separated streams are mixed in a ratio providing a product of the electrodialysis unit and optionally a residue with typical characteristics shown in Table 3. The product is mainly concentrate from the anode, possibly with the addition of diluate to control the pH level. The residue will be formed of any diluate that is not mixed in to the product. Typically the pH of the product in preferred implementations of the electrodialysis treatment is between 4-6, but treatment of the water will also occur within the broader pH range given below.

TABLE 3

| | pH | TRO (mg Cl/L) | ORP (mV) |
|---|---|---|---|
| Product | 2-8.5 | 400-1000 | 750-800 |
| Residue | 8.5-14 | | 800-900 |

In order to tailor the chemical characteristics of the two streams, cross-treatment may be applied. This may constitute of an arrangement allowing all of or a portion of one or both streams to be re-injected at the entrance to the opposite compartment to the compartment from which it arrived from. Thus, the concentrate stream produced by the anode could be cross-treated by re-injection into the cathode side of the electrodialysis unit. The characteristics of the stream(s) expressed by pH, ORP and TRO may be further tailored by this method and enable the amount of residual diluate after mixing to be reduced if mixing is applied in addition.

The mixing ratio will depend on the “quality” of the raw electrolyte, the size of the electrodes and the power applied.

The product of the electrodialysis unit enters the ballast water flow optionally in conjunction with the point of injection of the N₂, preferably immediately behind, and thus is optionally introduced into the water in conjunction with the process of super-saturation/oxygen removal. The residue, if any, is injected upstream in the main flow immediately in front of the filter.

FIGS. 2 to 9 illustrate an embodiment of an electrodialysis unit 8 that can be used to treat water. The electrodialysis unit may be used in the ballast water treatment system of FIG. 1 or in any other appropriate water treatment system. It can be used alone to provide a treatment effect, or alternatively it can be used in combination with other water treatment devices.

FIG. 2 illustrates an electrodialysis unit 8 including a stack of electrode chambers 30 sandwiched between two end plates 32. The electrode stack is clamped between the end plates 32 by screws 34. The electrode chambers 30 are placed together in sets of ten membrane cells separated by insulating layers. The sets of electrode chambers 30 and plastic insulating layers can be seen more clearly in FIG. 5. The electrode chambers 30 are arranged in sets in this fashion to enable a series connection of multiple sets of chambers 30. Water enters the electrode stack via cathode water inlets 50 and an anode water inlet 52 at the base of the electrode chambers 30 and then flows upward through the anode and cathode chambers. The water inlets 50, 52 are at the reverse side of the electrodialysis unit 8 in FIG. 2, but can be seen in FIG. 5 in which the unit 8 is shown from the opposite side. The diluate stream 11 from the cathode reaction and the concentrate stream 12 from the anode reaction exit the electrode stack via a concentrate outlet 36 and diluate outlets 38. As discussed above, it is advantageous to have a higher flow rate on the cathode side and so the preferred embodiment includes two water inlet pipes for the cathode side and consequently two outlet pipes 38 for the diluate, with only one concentrate outlet 36. The ratio of the flow rates can be about 3:1. Also shown in FIG. 2 are exposed ends 40 of the electrodes and the electrical connection board 42 for the electrical supply to the electrodes.

FIG. 3 shows a single electrode chamber 30. The unit 8 of FIG. 2 consists of a large number of these electrode chambers 30 stacked together. The electrode chamber 30 includes a titanium electrode plate 44 supported by and within two separators 46, which are placed one on either side of the electrode 44. A rubber seal 48 extends around the outer edge of the separators 46 and provides a water tight barrier enclosing the electrode chamber 30. The exposed ends 40 of the electrodes extend beyond the rubber seal 48 so that the electrical connections 42 can be made outside of the reaction zone.

Water enters the electrode chamber 30 via through holes 54 at one end and exits via through holes 54 at the other end. The through holes 54 are in fluid communication with the corresponding water inlets 50, 52 and water outlets 36, 38. Each separator 46 has through holes 54 for each of the three inlets 50, 52 and outlets 36, 38. Within the electrode chamber 30 the separators 46 are provided with flow guides for passage of water from the appropriate water inlet to the appropriate water outlet. Thus, the cathode electrode chamber will have flow guides to take water from the cathode water inlets 50 via the two outer through holes 54 at the inlet side, direct it to pass across the cathode, and then pass the diluate from the cathode reaction via further flow guides to the outer through holes 54 on the outlet side and hence to the diluate outlets 38. The anode electrode chamber will have flow guides to take water from the anode water inlet 52 via the central through hole 54 at the inlet side, direct it to pass across the anode, and then pass the concentrate from the anode reaction via further flow guides to the central through hole 54 on the outlet side and hence to the diluate outlet 36.

FIG. 4 shows an electrode plate 44 and seal 48 prior to attachment of the separators 46. The rubber seal 48 is bonded to the electrode plate 44 along two sides as shown in the Figure. The seal 48 is also on both front and back surfaces of the electrode plate 44. The exposed end 40 of the electrode plate 44 extends beyond the seal along one side of the electrode plate to permit electrical connection as set out above.

FIG. 5 is a partial cutaway view of an electrodialysis unit showing details of the flow distributor 56 for one of the cathode water inlets 52. FIG. 5 also more clearly shows the five sets of membrane cells separated by plastic insulating layers. The construction of the membrane cells is described in more detail below with reference to FIG. 9. In FIG. 5 one of the end plates 32 and each of the electrode chambers 30 are partially cut away to expose a circular passage formed by aligned through holes 54 (also partially cut away). This circular passage forms a first tube 58 of the flow distributor 56. The first tube 58 can be seen more clearly in the wireframe diagram of FIG. 8, which shows more detail of the fluid flow arrangement for the cathodes. The flow distributor 56 also includes a second tube 60, located concentrically within the through holes 54. In FIG. 5 this second tube 60 is inserted for one of the cathode inlets 50, but it is not shown for the other cathode inlet 50 or for the anode inlet 52. When the electrodialysis unit 8 is complete there is a second tube 60 in each water inlet, fitted concentrically with each set of through holes 54.

The second tube 60 includes holes 62 along its length. These holes 62 take the form of transverse slits cut on two sides of the second tube 60, and placed at the upper and lower sides of the second tube 60 when it is inserted in the first tube 58. FIG. 6 is a perspective view of the second tube 60 of the flow distributor 56 and shows further detail, including the holes 62 on the second, lower, side of the second tube 60.

Flow conditioning elements 64 on the separator 46′ for the cathode chamber are shown in FIG. 7A, which is a partial view of the lower part of a cathode separator 46′. The flow conditioning elements 64 are for evenly distributing the flow across the width W of the cathode flow path.

The three through holes 54 would align with through holes 54 in other separators 46 in the electrode stack to form the first tubes 58 of the flow distributors. The second tubes 60, which are not shown in FIG. 7, would be inserted into the aligned through holes 54, with holes 62 in the second tubes 60 allowing water to pass into the first tubes 58. In FIG. 7A since the separator 46 is for the cathode chamber the outer through holes 54 would be open to the cathode flow paths whereas the central through hole 54 would be sealed to prevent water from the anode inlet 52 entering the cathode chamber. This sealing may be achieved by an O-ring seal placed about the central through hole. Holes would hence be formed in the first tubes 58 at the two outer through holes 54 to permit water to pass from the water inlets 50, along the tubes 60, 58 and then to the cathode reaction area via the flow conditioning elements 64.

The flow conditioning elements 64 take the form of channels extending away from the through holes 54 in a fan shape in order to distribute water evenly across the entire width W of the cathode flow path. The channels are recessed into the separator 46′ and separated from each other by walls 66. When the two separators 46′ that form the cathode chamber are joined together the walls 66 on each separator 46′ face each other and come into contact so that the channels are sealed. Each channel has an end portion that is parallel with the flow direction through the cathode flow path. This helps reduce turbulence and promotes laminar flow.

FIG. 7B is a similar partial view of a separator 46″ for the anode chamber. This anode separator includes flow conditioning elements 65 for the anode flow path. As with the cathode flow conditioning elements 64 the anode flow conditioning elements 65 take the form of channels extending away from the through hole 54 in a fan shape in order to distribute water evenly across the entire width W of the anode flow path. Since the anode flow path is supplied with water from only the single central through hole 54 the anode flow conditioning elements 65 fan out over a larger angle than the cathode flow conditioning elements 64. This allows water from flow distributor 56 in the central through hole 54 to be evenly distributed over the anode flow path. The two outer through holes would be sealed, e.g. by an O-ring seal, to prevent water ingress from the cathode water supply. The anode flow conditioning elements 65 are recessed channels divided by walls 67. The flow conditioning part of the anode separator 46″ extends for a greater distance away from the through holes 54, since the leading edge of the anode is located at a greater distance from the water inlet, as discussed in more detail below with reference to FIG. 9.

FIG. 8 is a schematic wireframe drawing showing further detail of the flow distributor 56 and flow conditioning elements 64 for the cathode flow paths in the electrode stack. The detail of the flow conditioning elements 64 is omitted for clarity, but the fan shapes can be seen. Each cathode chamber has two symmetrical sets of flow conditioning elements 64 that join in similar fashion to two flow distributors 56 in the two outer through holes 54 of the separators 46. As discussed above, the through holes 54 are aligned to produce a first tube 58 of the flow distributor 56. The first tube 58 connects to each of the sets of flow conditioning elements 64 via holes on an upper side. A second tube 60 located concentrically within the first tube 58 supplies water to the first tube 58 from the two cathode inlets 50. Water passes between the first tube 58 and the second tube 60 via slit shaped holes 62 in upper and lower surfaces of the second tube.

The two tube flow distributor 56 acts to distribute water equally to each cathode chamber along the length of the electrode stack 30. The flow conditioning elements 64 provide even distribution of the water across the width W of each cathode flow path, and also promote laminar flow in the cathode flow paths.

For the anode chamber there is an arrangement similar to that shown in FIG. 8, but with water being distributed from only the central through hole 54 instead of from the two outer holes 54. The anode water flow path passes through a flow distributor 56 of identical design to the flow distributor 56 described above, using first and second tubes 58, 60. This flow distributor 56 would be formed using a first tube 58 created by the aligned central through holes 54 that connect to the anode water inlet 52.

After the incoming water passes through the flow distributors 56 and exits the flow conditioning elements 64, 65 it flows into the cathode and anode flow paths within the cathode and anode chambers. At this point, as explained below with reference to FIGS. 10 to 13, the water is equally distributed to each flow path along the electrode stack and evenly distributed across the width W of each flow path. The equal distribution of the water ensures an equal rate of reaction across each membrane cell in the electrode stack. The even distribution of water across each flow path width W means that the reaction occurs evenly over the width of the electrodes, and also promotes laminar flow in the cathode flow paths.

FIG. 9 is a cross-section through a portion of two cathodes 68 and one anode 70 at the point where water enters the cathode chambers and electrode chamber. A membrane 71 is located between the electrodes to form the membrane cells. The Figure shows a partial cross-section through two complete membrane cells (one either side of the anode 70) and two partial membrane cells (at the outside portions of the two cathodes 68).

FIG. 9 illustrates further features used to promote laminar flow through the electrode chambers, especially in the reaction zone of the cathode flow path. Incoming water for the cathode flow paths 72 arrives from the flow conditioning elements 64 of the separators 46′ as indicated by the arrow C. Water for the anode flow paths 74 arrives from the flow conditioning elements 65 as indicated by the arrow A. The water flow through the flow conditioning elements 64, 65 supplies two flow paths 72, 74 that pass along each of the two sides of the respective cathode 68 or anode 70.

The water exiting the flow conditioning elements 64, 65 is allowed to flow a fixed distance where the flow is undisturbed before the flow is divided gently into two equal flows that enter the flow paths 72, 74 on either side of the electrodes. This fixed distance helps the flow to recover from any disruptive effects that may have arisen from the previous flow guides. A gentle division of the flow is achieved through the shape of the electrode leading edge 76, which is wedge-shaped to minimise turbulence. The fixed distance of undisturbed flow in the preferred embodiment is around 10 mm.

It will be noted that the leading edge 76 of the anode 70 is placed at a larger distance away from the water inlet than the leading edge 76 of the cathode 68. The electrodialysis unit is designed such that water flows an additional fixed distance X over the cathode before being subjected to electrical treatment in the reaction zone. This further distance X allows any residual turbulence to dissipate and helps the flow to develop into a laminar flow before the seawater is subjected to any electrical current. This is achieved through the use of different lengths of anode 70 and cathode 68 which permits an offset cathode/anode configuration. In the preferred design shown herein this fixed distance X is around 30 mm with a gap of 2 mm between cathode 68 and membrane. The reaction zone begins when both the anode 70 and cathode 68 are present in sufficient proximity, in this case this will be after the distance X as marked on the Figure. In the reaction zone electrodialysis occurs and as the water passes along the anode flow paths 74 and cathode flow paths 72 in the reaction zone ion exchange occurs across the membranes 71, generating an acidic concentrate on the anode side and alkaline diluate on the cathode side as described above. The concentrate and diluate exit the electrodialysis unit via outlets 36, 38 and are used to treat water by mixing the concentrate with some or all of the diluate to provide a product of the electrodialysis unit, which is harmful to micro-organisms.

On each side of the anode 70 a spacer element 78 is included in the anode flow paths 74. To avoid turbulence there are no spacer elements on the cathode flow paths 72. In the cathode flow paths 72 conditioned flow is provided by the flow conditioning elements 64. This flow becomes more laminar as it passes across the 10 mm region of undisturbed flow, after which it is divided by the wedge shaped end 76 of the cathode 68. The water then flows along two cathode flow paths 72 for a further distance of 30 mm, which acts to further promote laminar flow. By the time the incoming water enters the reaction zone in the cathode flow paths 72 the flow is generally laminar. As discussed above, this laminar flow avoids the build-up of brucite deposits and also helps avoid build-up of other contaminants.

As discussed above, the preferred electrodialysis unit is made up of several sets of membrane cells, with each set of cells being formed by five anodes and six cathodes, with cathodes being placed at the outer ends. With this arrangement the outer cathodes would only have one active side, with one flow path along the inner side of the cathodes. The outer surfaces of the outer cathodes would not be active and would be blocked to prevent water flowing.

Computer modelling has been used to illustrate the advantageous effects of the preferred embodiment when it includes the flow distributor and flow conditioning elements.

FIGS. 10 and 11 show the effect of the two tube flow distributor system. FIG. 10 shows a plot of velocity across each of the cathode chambers along the electrode stack in a computer model when the preferred flow distributor 56 is not used, whereas FIG. 11 shows a plot of velocity across each of the cathode chambers along the electrode stack in a computer model when the preferred flow distributor 56 is used. The plots show flow velocity on the vertical axis with the horizontal axis showing the distance of the cathode flow path 72 from the cathode water inlet 50 at the end of the electrode stack. As can be seen by a comparison of the Figures when the flow distributor 56 is not used there is a considerably higher velocity in the cathode flow paths 72 at greater distances from the water inlet 50. When the flow distributor 56 is used the water is significantly more evenly distributed along the length of the electrode stack.

FIGS. 12 and 13 show the effect of the flow conditioning elements 64 on water flow across the cathode flow paths 72. FIG. 12 shows a plot of velocity across the width of a cathode flow path in a computer model when the preferred flow conditioning elements 64 are not included, and the water instead passes through a fan shaped region without the channels 64 or walls 66. FIG. 13 shows a plot of velocity across the width of a cathode flow path in a computer model when the preferred flow conditioning elements 64 are present. The vertical axis shows flow velocity and the horizontal axis shows the distance across the width of a cathode flow path 72. The peaks in each plot illustrate the likely velocity at points across the width W of the cathode flow path 72. The sharp troughs are due to the effect of the flow conditioning elements at the exit of the chamber which soon dissipate away. As can be seen, when the average flow across the chamber is studied, the channels 64 and walls 66 provide for a more even distribution of velocity and thus flow across the width W of the cathode flow path 72. When they are not present the velocity and thus flow is less even and this would lead to turbulence and secondary flows in subsequent parts of the cathode flow path 72.

1. An electrodialysis unit for treating water comprising: a membrane cell, an anode flow path for directing a portion of an incoming water flow to an anode side of the membrane cell, a cathode flow path for directing a portion of an incoming water flow to a cathode side of the membrane cell, a temperature monitoring device for monitoring the temperature of the water and a heater for increasing the temperature of the water in the anode flow path before it reaches the membrane cell, wherein the heater is arranged to operate to increase the temperature of the water in the anode flow path when the original water temperature is below a predetermined level.

2. An electrodialysis unit as claimed in claim 1, wherein the water in the cathode flow path is passed to the membrane cell without any pre-heating.

3. An electrodialysis unit as claimed in claim 1, wherein the flow rate in the anode flow path is lower than the flow rate in the cathode flow path.

4. An electrodialysis unit as claimed in claim 3, wherein the volume flow rate on the cathode side is at least twice the volume flow rate on the anode side.

5. An electrodialysis unit as claimed in claim 1, wherein the predetermined temperature level of the incoming water that triggers heating of the anode water is selected such that a drop in efficiency of the anode reactions is avoided.

6. (canceled)

7. An electrodialysis unit as claimed in claim 1, wherein the heater is operated to increase the temperature of the incoming water when the original temperature is below 15° C.

8. An electrodialysis unit as claimed in claim 1, wherein the heater is arranged to operate to increase the temperature of the water in the anode flow path to above 15° C.

9. An electrodialysis unit as claimed in claim 1, wherein the heater is arranged to operate to increase the temperature of the water in the anode flow path to above 16° C.

10. An electrodialysis unit as claimed in claim 1, wherein the heater is arranged to operate to increase the temperature of the water in the anode flow path to a temperature that is sufficient to maintain a temperature of above 15° C. on the anode side of the membrane cell along the whole extent of the membrane cell.

11. An electrodialysis unit as claimed in claim 1, wherein the heater is powered by waste heat, for example an engine cooling system or heat recovered from an engine exhaust.

12. A ballast water treatment apparatus comprising an electrodialysis unit as claimed in claim 1.

13. A vessel comprising the ballast water treatment apparatus of claim 12.

14. A method of treating water by electrodialysis using a membrane cell, wherein the membrane cell is connected to an anode flow path for directing a portion of an incoming water flow to an anode side of the membrane cell and a cathode flow path for directing a portion of an incoming water flow to a cathode side of the membrane cell, the method comprising: monitoring the temperature of incoming water and increasing the temperature of the water in the anode flow path before it reaches the membrane cell if the original water temperature is below a predetermined level.

15. A method as claimed in claim 14, wherein the water for the cathode side of the membrane cell is not heated.

16. A method as claimed in claim 14, being a method of treating ballast water on board a vessel such as a ship.

17. A method as claimed in claim 14, comprising heating the water by using recovered heat, which may for example be waste heat from an engine cooling system or heat recovered from an engine exhaust.

18. A method as claimed in claim 14, comprising increasing the temperature of the incoming water when the original temperature is below 10° C., preferably when the original temperature is below 15° C.

19. A method as claimed in claim 14, wherein increasing the temperature of the water in the anode flow path includes heating the water to above 15° C. , preferably above 16° C.

20. A method as claimed in claim 14, wherein the temperature that the anode water is heated to is sufficient to maintain a temperature of above 15° C., preferably above 16° C. on the anode side along the whole extent of the membrane cell.

21. A method of manufacturing an electrodialysis unit comprising providing a membrane cell, providing an anode flow path for directing a portion of an incoming water flow to an anode side of the membrane cell, providing a cathode flow path for directing a portion of an incoming water flow to a cathode side of the membrane cell, providing a temperature monitoring device for monitoring the temperature of the water, and providing a heater for increasing the temperature of the water in the anode flow path before it reaches the membrane cell, the heater being arranged to operate to increase the temperature of the water in the anode flow path when the original water temperature is below a predetermined level.
